(19) United States
(12) Patent Application Publication
(10) Pub. No.: US 2026/0320167 A1
(43) Pub. Date: Oct. 15, 2026

(54) CHIPCARD ENROLLMENT

(71) Applicant: Infineon Technologies AG, Neubiberg (DE)

(72) Inventor: Xianming Huang, Xi Cheng (CN)

(21) Appl. No.: 19/548,444

(22) Filed: Feb. 24, 2026

(30) Foreign Application Priority Data
Apr. 14, 2025 (DE) 102025114566.0

(51) Int. Cl. G06F 21/32; G06F 21/34

(52) U.S. Cl. CPC G06F 21/32; G06F 21/34; G06F 2221/2117

(57) ABSTRACT

A method of enrolling a chipcard including a fingerprint sensor to an application, the method including positioning the chipcard relative to a communication terminal device in an enrollment communication position to enable an antenna of the chipcard to communicate with an antenna of the communication terminal device, holding the chipcard at the enrollment communication position using a communication terminal device-external holding structure and a magnet in the communication terminal device, wherein the chipcard is held between the communication terminal device and the communication terminal device-external holding structure, and the communication terminal device performing an enrollment process including: detecting a fingerprint of a user using the fingerprint sensor, and authenticating and enrolling the user to the application using the detected fingerprint of the user.

### TECHNICAL FIELD

The present disclosure relates to a method of enrolling a chipcard, a system for enrolling a chipcard, and a holding structure.

### BACKGROUND

Biometric authentication is becoming more prevalent in our daily lives. Secure Elements (SE), which may, for example, be provided by tamper-resistant processors, and biometric technologies may provide a platform to offer fast, convenient, and trusted payments relying on biometric identification, e. g. using fingerprints: Users may verify their identity simply by placing a finger on a fingerprint sensor integrated in the card and tapping the card at the terminal. Contactless payment cards with biometric identification may pave the way for even more convenient, trusted user experiences.

Biometrically authenticated payment concepts may, for example, combine a contactless Secure Element and a fingerprint sensor to enable the cardholder's biometric credentials to be recorded, processed, matched, and stored on an all-in-one biometric payment card.

### SUMMARY

A method of enrolling a chipcard including a fingerprint sensor to an application is provided. The method includes positioning the chipcard relative to a communication terminal device in an enrollment communication position to enable an antenna of the chipcard to communicate with an antenna of the communication terminal device, holding the chipcard at the enrollment communication position using a communication terminal device-external holding structure and a magnet in the communication terminal device, wherein the chipcard is held between the communication terminal device and the communication terminal device-external holding structure, and the communication terminal device performing an enrollment process including: detecting a fingerprint of a user using the fingerprint sensor, and authenticating and enrolling the user to the application using the detected fingerprint of the user.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1A schematically illustrates a system for enrolling a chipcard including a fingerprint sensor to an application in accordance with various embodiments.

FIG. 1B and FIG. 1C illustrate a method of enrolling a chipcard including a fingerprint sensor to an application in accordance with various embodiments, for example, using the system of FIG. 1A.

Each of FIGS. 2A to 2C schematically illustrates a holding structure in accordance with various embodiments.

FIG. 3 shows a flow diagram of a method of enrolling a chipcard including a fingerprint sensor to an application in accordance with various embodiments.

### DETAILED DESCRIPTION

In order to pave the way for the smooth adoption of biometric payment cards, fingerprint enrollment is an essential process for manufacturers and issuers of biometric payment cards.

Various enrollment options are presently in use, which are listed below together with their individual drawbacks:
Smartphone enrollment: A mobile application on the smartphone enables cardholders to independently and easily (e. g., at home) enroll their fingerprints to an application on their chipcard. Drawback: Since the mobile phone acts as a contactless card reader, a position of the chipcard may need to be tried out and/or adjusted several times due to a weak contactless field strength, which may be sufficiently high for the enrollment procedure only near an optimal relative positioning of chipcard and mobile phone. Since, however, the fingerprint sensor on the chipcard is required to be pressed several times during the enrollment process, it is easy to cause the position of the card to move, which may lead to a failure of fingerprint acquisition.
In-field enrollment (Point-of-Sales (PoS) enrollment): cardholders enroll their chipcard just by using it and placing a finger on the card sensor during contactless communication. The PoS terminal may ask the user to also enter a personal identification number (PIN). This enrollment procedure may be predefined by the PoS system. Drawback: A large fraction of the cost may be caused by an upfront and invisible need of the PoS system to be updated and configured in advance based on the biometric payment card to support new cards coming in. Additionally, cardholders may be required to go to a specific PoS counter, which may be a cause of dissatisfaction.
Sleeve enrollment: Cardholders may use a contact-based sleeve enrollment device to enroll their fingerprint to an application on the chipcard. Normally, a ready-to-use sleeve may be enclosed with the card upon delivery. Drawback: These ready-to-use sleeves may need to be sourced from a partner, incurring per-unit-costs, and be delivered to the user/cardholder. Typically, the user may only use the enrollment device once in the entire life cycle of the card. In addition, the sleeve enrollment device may also require battery power.

Embodiments described herein use and/or provide a holding structure that is configured to easily fix a chipcard that includes a fingerprint sensor (“chipcard” or “card” for short) in a predefined relative position on a communication terminal device (e. g., a smartphone) and to thereby provide the chipcard in a stable position in which the chipcard is not easy to be moved (not even when the fingerprint sensor is touched by a fingertip), and in which, at the same time, an efficient and stable contactless communication between the chipcard and the communication terminal device is ensured.

In various embodiments, the holding structure may be manufactured at a low price, which means that an enrollment system including the holding structure and the communication terminal device (e. g., the smartphone), which may typically be already owned by the card owner, may be provided at low cost and with a high flexibility and ease of use.

In various embodiments, a magnet in the communication terminal device may be used for providing both a holding force for holding the chipcard in place and for providing an essentially unique mounting position for the chipcard in which the efficient contactless communication between the chipcard and the communication terminal device is ensured and the fingerprint sensor remains accessible.

In various embodiments, the magnet may be provided by iPhone's Magsafe, and a low-cost holding structure, e. g., a physical card sleeve (without any electronic components) may be provided to enable a chipcard that is arranged in the holding structure or between the holding structure and the communication terminal device to be automatically positioned (more or less) in the best relative position with respect to a contactless antenna of the iPhone. Simultaneously, it may be ensured that the fingerprint sensor on the chipcard is not obscured by the iPhone.

In various embodiments, communication terminal devices of other manufacturers that include a magnet with the purpose of providing an attachment structure for attaching a magnetic or magnetizable item on an outside of the communication terminal device may be used as an alternative to the iPhone.

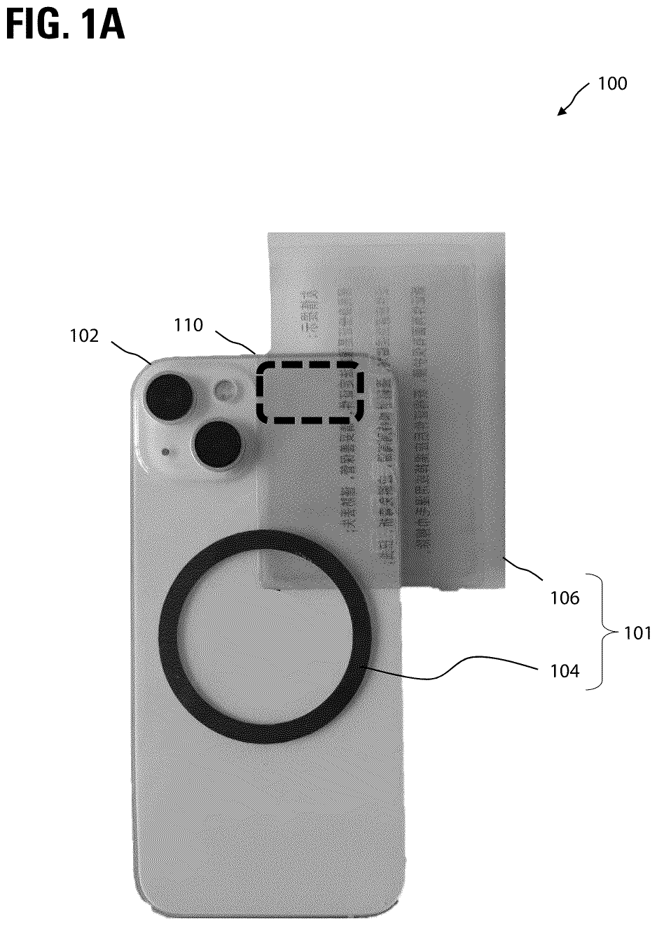

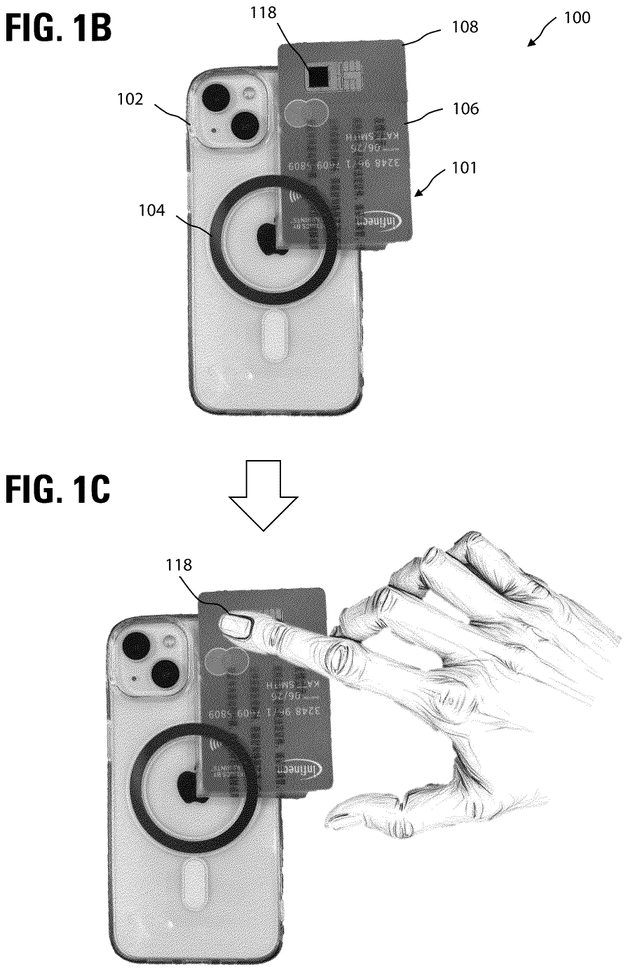

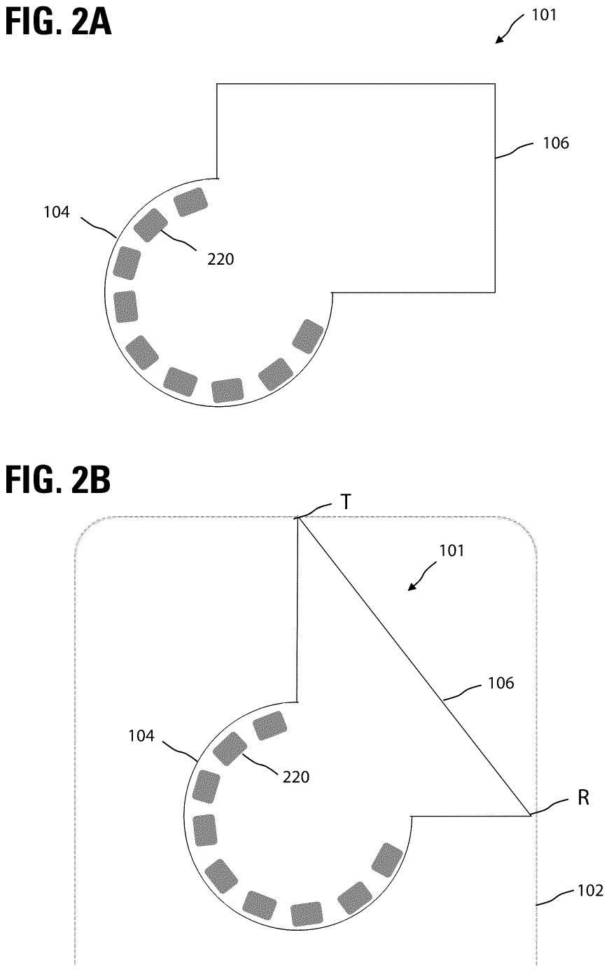

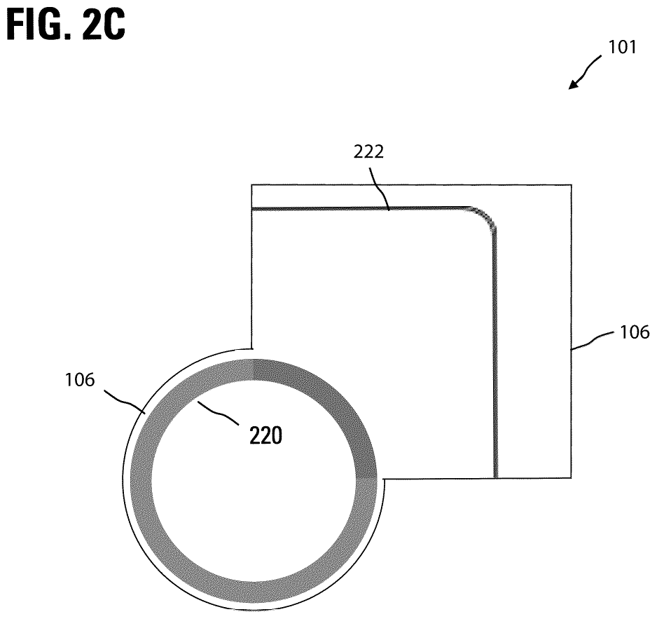

FIG. 1A schematically illustrates a system 100 for enrolling a chipcard 108 including a fingerprint sensor 118 to an application in accordance with various embodiments, and FIG. 1B and FIG. 1C illustrate a method of enrolling a chipcard 108 including a fingerprint sensor 118 to an application in accordance with various embodiments, for example, using the system 100 of FIG. 1A.

The system 100 includes a communication terminal device 102, for example, a smartphone, for example, an iPhone, or any other type of communication terminal device 102 that is configured for wireless communication (for example, by including an antenna) and further includes a magnet configured to serve as an attachment device for removably attaching magnetic or magnetizable items to an outside of the communication terminal device 102.

The system 100 further includes a communication terminal device-external holding structure 101 removably arrangeable or arranged on the communication terminal device 102, e. g., via interaction with the magnet.

Neither the antenna nor the magnet are shown in FIG. 1A, since they are arranged inside the communication terminal device 102, but their respective approximate locations are indicated by the ring, which is part of the communication terminal device-external holding structure 101 and arranged to correspond to, e. g. overlap or essentially overlap with, the magnet, and by the dashed box, which indicates an enrollment communication portion 110 of the antenna in the communication terminal device 102, which is supposed to be overlapped by a card antenna included in the chipcard 108, or at least a suitable portion thereof.

In various embodiments, in the system 100, the communication terminal device-external holding structure 101 is arranged or arrangeable to enable holding the chipcard 108 in an enrollment communication position between the communication terminal device 102 and the communication terminal device-external holding structure 101.

The enrollment communication position in which the chipcard 108 needs to be arranged relative to the communication terminal device 102 may be predetermined for each type (e. g., manufacturer) of communication terminal devices 102, e. g., for Apple iPhones vs. those of other manufacturers.

The communication terminal device-external holding structure 101 may be configured accordingly for holding the chipcard 108 in the enrollment communication position. Various embodiments will be described later.

In various embodiments, the system 100 is configured to enable, in response to the chipcard 108 being positioned in the enrollment communication position (this is indicated in an exemplary fashion in FIG. 1B), the antenna of the chipcard 108 to communicate with the antenna of the communication terminal device 102, and the communication terminal device 102 to perform an enrollment process including: detecting a fingerprint of a user using the fingerprint sensor 118 (see FIG. 1C for an illustrative example), and authenticating and enrolling the user to the application using the detected fingerprint of the user.

The enrollment may include storing the detected fingerprint of the user, for example, using a secure element (SE), which may be understood as a secure operating system (OS) in a tamper-resistant processor chip or secure component. The authentication of the user that may be required as part of the enrollment process may, for example, include providing a personal identification number (PIN).

Each of FIGS. 2A to 2C schematically illustrates a communication terminal device-external holding structure 101 in accordance with various embodiments.

The communication terminal device-external holding structure 101 may include an attachment portion 104 that may include or consist of a magnetic or magnetizable structure 220. The communication terminal device-external holding structure 101 arranged on the communication terminal device may be held in place by magnetic interaction between the magnet and the magnetic or magnetizable structure 220.

The magnetic or magnetizable structure 220 that is configured as a magnetic structure may include one or more magnets. The magnet(s) may in various embodiments be arranged with one predefined magnetic pole configured to face the magnet in the communication terminal device 102 when the communication terminal device-external holding structure 101 is arranged to provide the enrollment communication position, or with both magnetic poles configured to face, e. g., in predefined positions, the magnet when the communication terminal device-external holding structure 101 is arranged to provide the enrollment communication position. A predefined pattern of magnets alternatingly placed with respect to the poles that face the magnet may allow to configure the system 100 to have the communication terminal device-external holding structure 101 to snap in place in the enrollment communication position when it is brought into a position that is close to the enrollment communication position.

In various embodiments, the magnetic or magnetizable structure 220 may not be magnetic itself, but simply magnetizable, e. g., include or consist of a magnetizable metal, e. g., as a continuous or as a multi-part-structure.

The magnetic or magnetizable structure 220 may in various embodiments have a shape that is configured to match a shape of the magnet, optionally, for example, a ring shape or a partial ring shape.

Each of FIGS. 2A to 2C show exemplary embodiments of the holding structure 101 in which the magnetic or magnetizable structure 220 has a ring shape (see FIG. 2C) or a partial ring shape (FIGS. 2A and 2B), either segmented (see FIGS. 2A and 2B; the segments may, for example, be formed by individual magnets that may be arranged in the same way regarding their poles, or, for example, with a predefined pole pattern, e. g., alternating with respect to their poles) or as a full ring (see FIG. 2C). Variations are possible, for example, a non-segmented partial ring or a segmented full ring, or, for example, shapes that are non-circular or different from a ring shape, for example, a cross-like configuration, or any other arrangement of the magnet and the corresponding magnetic or magnetizable structure 220 that allows to magnetically firmly but removably attach the communication terminal device-external holding structure 101 to the communication terminal device 102.

The communication terminal device-external holding structure 101 may further include a chipcard holding portion 106. When the communication terminal device-external holding structure 101 holds the chipcard 108 in the enrollment communication position, the chipcard holding portion 106 may overlap or be adjacent to the enrollment communication portion 110, wherein the enrollment communication portion 110 is configured to enable the antenna of the chipcard 108 to communicate with the antenna of the communication terminal device 102 when the chipcard 108 is arranged to at least partially overlap the enrollment communication portion 110.

The communication terminal device-external holding structure 101 may optionally include a recess or a pocket for partially receiving the chipcard 108 therein. The chipcard 108 may only be partially received in the communication terminal device-external holding structure 101, because at least the fingerprint sensor 118 may need to remain uncovered.

In various embodiments, the chipcard holding portion 106 and the attachment portion 104 may be integrally formed.

As already outlined in other words above, in various embodiments, the attachment portion 104 may be configured to define at least a position (e. g., where a central point of the chipcard holding portion 106 and/or the magnet(s) are to be arranged on an outside of the communication terminal device 102), and optionally also an angle with which the communication terminal device-external holding structure 101 is to be arranged, for example, with respect to a longitudinal axis of the communication terminal device 102 (e. g. using the pattern of different poles of the magnets of the magnetic structure that is configured to align with corresponding individual magnets of the magnet provided in the communication terminal device 102.

Alternatively or additionally, information may be provided on or by the communication terminal device-external holding structure 101, e. g., on the chipcard holding portion 104 (for example printed onto it) and/or by a shape of the chipcard holding portion, about the angle. For example, as shown in an exemplary fashion in FIG. 2B, predefined points T, R of the chipcard holding portion 104 may be required to be arranged to match predefined corresponding points of the communication terminal device 102 (in FIG. 2B the points T, P, which are to be arranged to align with a top edge (point T) and a right edge (point R), respectively, of the communication terminal device 102. FIG. 2C shows an exemplary embodiment in which an indicator 222 that is to be arranged matching the outline of the communication terminal device 102 is printed on the chipcard holding portion 104.

In Example 11, the subject matter of any of Examples 7 to 10 may optionally include that the communication terminal device-external holding structure further includes at least one indicator, e. g., a group of indicators, indicating a predetermined position of the communication terminal device-external holding structure with respect to the communication terminal device 102.

The communication terminal device-external holding structure 101 may, in various embodiments, include cardboard and/or a polymer, e. g., plastic (in addition to the magnetic or magnetizable material of the chipcard holding portion 104).

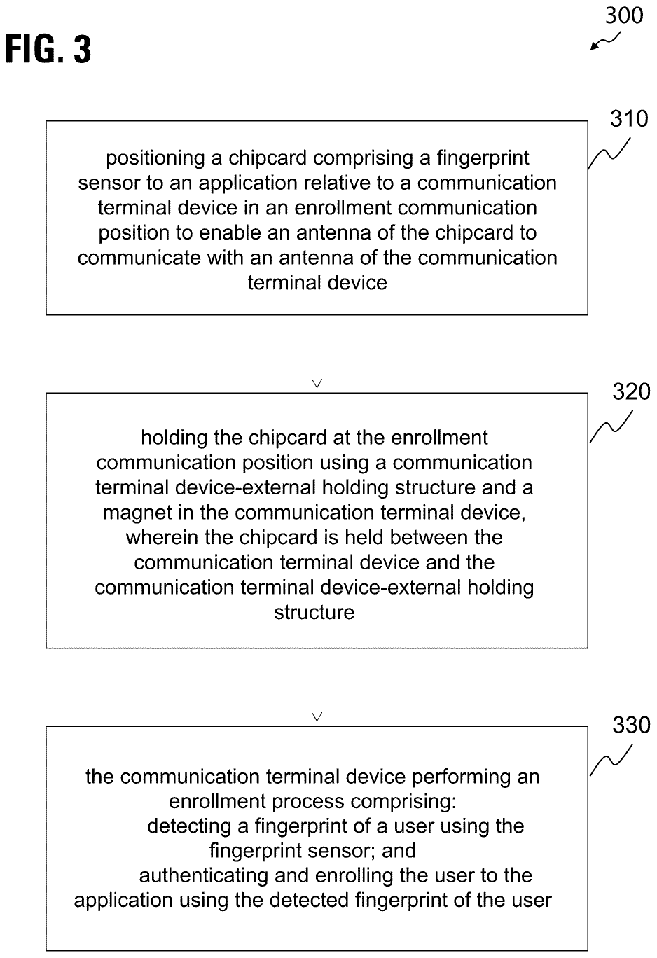

FIG. 3 shows a flow diagram 300 of a method of enrolling a chipcard including a fingerprint sensor to an application in accordance with various embodiments.

The method includes positioning the chipcard relative to a communication terminal device in an enrollment communication position to enable an antenna of the chipcard to communicate with an antenna of the communication terminal device (in 310), holding the chipcard at the enrollment communication position using a communication terminal device-external holding structure and a magnet in the communication terminal device, wherein the chipcard is held between the communication terminal device and the communication terminal device-external holding structure (in 320), and the communication terminal device performing an enrollment process including: detecting a fingerprint of a user using the fingerprint sensor, and authenticating and enrolling the user to the application using the detected fingerprint of the user (in 330).

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

Various examples will be illustrated in the following:

Example 1 is a method of enrolling a chipcard including a fingerprint sensor to an application. The method includes positioning the chipcard relative to a communication terminal device in an enrollment communication position to enable an antenna of the chipcard to communicate with an antenna of the communication terminal device, holding the chipcard at the enrollment communication position using a communication terminal device-external holding structure and a magnet in the communication terminal device, wherein the chipcard is held between the communication terminal device and the communication terminal device-external holding structure, and the communication terminal device performing an enrollment process including: detecting a fingerprint of a user using the fingerprint sensor, and authenticating and enrolling the user to the application using the detected fingerprint of the user.

In Example 2, the subject matter of Example 1 may optionally include that the communication terminal device-external holding structure includes a magnetic or magnetizable structure and the holding the chipcard at the enrollment communication position includes holding by magnetic interaction between the magnet and the magnetic or magnetizable structure.

In Example 3, the subject matter of Example 1 or 2 may optionally further include arranging the communication terminal device-external holding structure on the communication terminal device.

In Example 4, the subject matter of Example 3 may optionally include that the arranging includes arranging an attachment portion of the communication terminal device-external holding structure that includes a magnetic or magnetizable structure overlapping the magnet, and arranging a chipcard holding portion of the communication terminal device-external holding structure overlapping or adjacent to an enrollment communication portion of the communication terminal device.

In Example 5, the subject matter of Example 3 or 4 may optionally include that the communication terminal device-external holding structure further includes at least one indicator indicating a predetermined position of the communication terminal device-external holding structure with respect to the communication terminal device, and that the method further includes using the at least one indicator for arranging the communication terminal device-external holding structure in the predetermined position.

In Example 6, the subject matter of Example 5 may optionally include that the indicator includes at least one of a group of indicators, the group consisting of: an outline of the communication terminal device, and at least one marking.

Example 7 is a system for enrolling a chipcard including a fingerprint sensor to an application, the system including a communication terminal device including an antenna and a magnet, and a communication terminal device-external holding structure removably arranged on the communication terminal device, wherein the communication terminal device-external holding structure is arranged to enable holding the chipcard in an enrollment communication position between the communication terminal device and the communication terminal device-external holding structure, and wherein the system is configured to enable, in response to the chipcard being positioned in the enrollment communication position, an antenna of the chipcard to communicate with the antenna of the communication terminal device, and the communication terminal device to perform an enrollment process including: detecting a fingerprint of a user using the fingerprint sensor, and authenticating and enrolling the user to the application using the detected fingerprint of the user.

In Example 8, the subject matter of Example 7 may optionally include that the communication terminal device-external holding structure includes a magnetic or magnetizable structure, and the communication terminal device-external holding structure arranged on the communication terminal device is held in place by magnetic interaction between the magnet and the magnetic or magnetizable structure.

In Example 9, the subject matter of Example 7 or 8 may optionally include that the communication terminal device includes an enrollment communication portion, wherein the communication terminal device-external holding structure includes: an attachment portion that includes a magnetic or magnetizable structure overlapping the magnet, and a chipcard holding portion overlapping or adjacent to the enrollment communication portion, wherein the enrollment communication portion is configured to enable the antenna of the chipcard to communicate with the antenna of the communication terminal device when the chipcard is arranged to at least partially overlap the enrollment communication portion.

In Example 10, the subject matter of Example 9 may optionally include that the chipcard holding portion and the attachment portion are integrally formed.

In Example 11, the subject matter of any of Examples 7 to 10 may optionally include that the communication terminal device-external holding structure further includes at least one indicator indicating a predetermined position of the communication terminal device-external holding structure with respect to the communication terminal device.

In Example 12, the subject matter of Example 11 may optionally include that the indicator includes at least one of a group of indicators, the group consisting of: an outline of the communication terminal device, and at least one marking.

In Example 13, the subject matter of any of Examples 7 to 12 may optionally include that the communication terminal device-external holding structure includes cardboard and/or plastic.

In Example 14, the subject matter of any of Examples 7 to 13 may optionally include that the communication terminal device-external holding structure includes a pocket for partially receiving the chipcard therein.

In Example 15, the subject matter of any of Examples 7 to 14 may optionally include that the communication terminal device is a smartphone.

In Example 16, the subject matter of Example 15 may optionally include that the smartphone is an iPhone.

In Example 17, the subject matter of Example 8 may optionally include that the magnetic or magnetizable structure has a shape that is configured to match a shape of the magnet.

In Example 18, the subject matter of Example 8 or 17 may optionally include that the magnetic or magnetizable structure has a ring shape or a partial ring shape.

In Example 19, the subject matter of any of Examples 7 to 18 may optionally include that the communication terminal device-external holding structure is configured to only partially cover the chipcard, leaving at least the fingerprint sensor uncovered.

Example 20 is a holding structure configured to be attached to a communication terminal device for enrolling a chipcard including a fingerprint sensor to an application, the holding structure including: an attachment portion that includes a magnetic or magnetizable structure, and a chipcard holding portion integrally formed with the attachment portion, wherein the holding structure is further configured to be attachable to the communication terminal device in a position in which the holding structure enables holding the chipcard in an enrollment communication position between the communication terminal device and the holding structure, wherein, in the position: the attachment portion overlaps a magnet included in the communication terminal device, and the chipcard holding portion overlaps or is adjacent to an enrollment communication portion of the communication terminal device, wherein the enrollment communication portion is configured to enable an antenna of the chipcard to communicate with an antenna of the communication terminal device when the chipcard is arranged to at least partially overlap the enrollment communication portion, thereby enabling the communication terminal device to perform an enrollment process including: detecting a fingerprint of a user using the fingerprint sensor, and authenticating and enrolling the user to the application using the detected fingerprint of the user.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A method of enrolling a chipcard having a fingerprint sensor to an application, the method comprising:
positioning the chipcard relative to a communication terminal device in an enrollment communication position to enable an antenna of the chipcard to communicate with an antenna of the communication terminal device;
holding the chipcard at the enrollment communication position using a communication terminal device-external holding structure and a magnet in the communication terminal device, wherein the chipcard is held between the communication terminal device and the communication terminal device-external holding structure; and
the communication terminal device performing an enrollment process comprising:
detecting a fingerprint of a user using the fingerprint sensor; and
authenticating and enrolling the user to the application using the detected fingerprint of the user.

2. The method of claim 1, wherein the communication terminal device-external holding structure comprises a magnetic or magnetizable structure and the holding the chipcard at the enrollment communication position comprises holding by magnetic interaction between the magnet and the magnetic or magnetizable structure.

3. The method of claim 1, further comprising:
arranging the communication terminal device-external holding structure on the communication terminal device.

4. The method of claim 3, wherein the arranging comprises:
arranging an attachment portion of the communication terminal device-external holding structure that comprises a magnetic or magnetizable structure overlapping the magnet; and
arranging a chipcard holding portion of the communication terminal device-external holding structure overlapping or adjacent to an enrollment communication portion of the communication terminal device.

5. The method of claim 3,
wherein the communication terminal device-external holding structure further comprises at least one indicator indicating a predetermined position of the communication terminal device-external holding structure with respect to the communication terminal device; and
wherein the method further comprises using the at least one indicator for arranging the communication terminal device-external holding structure in the predetermined position.

6. The method of claim 5, wherein the indicator is selected from a group of indicators consisting of an outline of the communication terminal device and at least one marking.

7. A system for enrolling a chipcard having a fingerprint sensor to an application, the system comprising:
a communication terminal device comprising an antenna and a magnet; and
a communication terminal device-external holding structure removably arranged on the communication terminal device,
wherein the communication terminal device-external holding structure is arranged to enable holding the chipcard in an enrollment communication position between the communication terminal device and the communication terminal device-external holding structure,
wherein the system is configured to enable, in response to the chipcard being positioned in the enrollment communication position, an antenna of the chipcard to communicate with the antenna of the communication terminal device, and
wherein the communication terminal device is configured to perform an enrollment process comprising:
detecting a fingerprint of a user using the fingerprint sensor; and
authenticating and enrolling the user to the application using the detected fingerprint of the user.

8. The system of claim 7, wherein the communication terminal device-external holding structure comprises a magnetic or magnetizable structure, and the communication terminal device-external holding structure arranged on the communication terminal device is held in place by magnetic interaction between the magnet and the magnetic or magnetizable structure.

9. The system of claim 7,
wherein the communication terminal device comprises an enrollment communication portion, and
wherein the communication terminal device-external holding structure comprises:
an attachment portion that comprises a magnetic or magnetizable structure overlapping the magnet; and
a chipcard holding portion overlapping or adjacent to the enrollment communication portion, wherein the enrollment communication portion is configured to enable the antenna of the chipcard to communicate with the antenna of the communication terminal device when the chipcard is arranged to at least partially overlap the enrollment communication portion.

10. The system of claim 9, wherein the chipcard holding portion and the attachment portion are integrally formed.

11. The system of claim 7, wherein the communication terminal device-external holding structure further comprises at least one indicator indicating a predetermined position of the communication terminal device-external holding structure with respect to the communication terminal device.

12. The system of claim 11, wherein the indicator comprises an indicator selected from a group of indicators consisting of an outline of the communication terminal device and at least one marking.

13. The system of claim 7, wherein the communication terminal device-external holding structure comprises cardboard and/or plastic.

14. The system of claim 7, wherein the communication terminal device-external holding structure comprises a pocket for partially receiving the chipcard therein.

15. The system of claim 7, wherein the communication terminal device is a smartphone.

16. The system of claim 15, wherein the smartphone is an iPhone.

17. The system of claim 8, wherein the magnetic or magnetizable structure has a shape that is configured to match a shape of the magnet.

18. The system of claim 8, wherein the magnetic or magnetizable structure has a ring shape or a partial ring shape.

19. The system of claim 7, wherein the communication terminal device-external holding structure is configured to only partially cover the chipcard, leaving at least the fingerprint sensor uncovered.

20. A holding structure configured to be attached to a communication terminal device for enrolling a chipcard having a fingerprint sensor to an application, the holding structure comprising:
an attachment portion that comprises a magnetic or magnetizable structure; and
a chipcard holding portion integrally formed with the attachment portion,
wherein the holding structure is further configured to be attachable to the communication terminal device in a position in which the holding structure enables holding the chipcard in an enrollment communication position between the communication terminal device and the holding structure, wherein, in the position:
the attachment portion overlaps a magnet comprised in the communication terminal device, and
the chipcard holding portion overlaps or is adjacent to an enrollment communication portion of the communication terminal device, wherein the enrollment communication portion is configured to enable an antenna of the chipcard to communicate with an antenna of the communication terminal device when the chipcard is arranged to at least partially overlap the enrollment communication portion, thereby enabling the communication terminal device to perform an enrollment process comprising:
detecting a fingerprint of a user using the fingerprint sensor; and
authenticating and enrolling the user to the application using the detected fingerprint of the user.
